(19) United States
(12) Patent Application Publication
(10) Pub. No.: US 2012/0229614 A1
(43) Pub. Date: Sep. 13, 2012

(54) Information and Guidance System

(76) Inventor: Harlan Jacobs, Minneapolis, MN (US)

(21) Appl. No.: 13/413,136

(22) Filed: Mar. 6, 2012

Related U.S. Application Data
(60) Provisional application No. 61/449,828, filed on Mar. 7, 2011.

(51) Int. Cl. H04N 7/18

(52) U.S. Cl. 348/62; 348/E07.085

(57) ABSTRACT

The present invention is a navigation and assistance system for individual users traveling from a starting point to a desired destination. A communication device is provided that can communicate the user's GPS location coordinates to a guide person at a remote facility. The communication device also provides for verbal and audio communication between the user and their guide. One or more video cameras are mounted to or held by the user and are connected to the communication device for sending streaming video information from the one or more cameras to the guide person. With the video information regarding the user's immediate surroundings, their GPS location and the verbal and audio communication link with the user the guide person can provide information and directions to the user to as they move one location to another.

### FIELD OF THE INVENTION

The present invention is generally related to navigational and information systems and more specifically to navigational and informational systems for pedestrians that use video, audio and GPS information provided to a guide person which person then provides assistance to the user as they move from one location to another.

### BACKGROUND OF THE INVENTION

With the advent of the US military developed global positioning satellite system (GPS) for determining very precisely one's position at any point on the surface of the earth, navigation took a quantum leap forward. Once that system became available for civilian applications, a wide range of devices were created to assist in personal navigation.

Some of the first devices available to the public were used by private pilots to help them fly with greater confidence as to their position and particularly when flying under instrument conditions. As the price and size of GPS systems came down the use thereof proliferated to automobiles and even to handheld devices such as cell phones. GPS devices now include the ability to provide verbal directions to the user as their progress is tracked to a particular requested destination. Such systems can also provide a route map on a video display. In the case of a handheld device connected to the internet the route information can be generated by combining the GPS coordinate generating capability and the use of database map systems such as offered by Mapquest® or Google®.

Devices now exist for assisting those with impaired vision that include voice recognition software ability to permit verbal control commands in addition to providing verbal direction instructions. Such devices can also include three dimensional or tactile screens that can also convey map and other data to persons having reduced or no sight. It is also known to implant buildings, and other potential obstacles such as lamp posts, street signs, bus stop benches and the like with radio frequency identification (RFID) chips. An RFID reading device can be incorporated into a cane, for example, and provide a sight impaired person audio information about their immediate surroundings. This technology could be used with a direction device but would not be able to provide turn by turn directions as it lacks the GPS and map database information.

A problem with the foregoing technology for visually handicapped individuals is that it can not take into account short term events that might present obstructions to their passage. A delivery truck may be in the process of being unloaded and various large items may be placed, albeit temporarily, in the path of the sight impaired person. It is also possible that construction has caused the need for a detour. Detours may be dealt with in the current art direction systems depending upon how frequently and accurately the map database information is updated. However, transient events like deliveries, vehicle accidents, and so forth can not be dealt with in such a manner. It is also predicted that with the advent of newer fully electric vehicles, the ability to hear an approaching vehicle and avoid an untimely road crossing will be compromised.

When a non-sighted individual travels a certain route as a matter of their daily routine their need for electronic directional aides my be diminished to a certain extent, however when they are trying to make their way through a new area for the first time, whether it is close to home or where they are on vacation, electronic direction assistance can be critically important. Unfortunately, as referred to above, such systems can not account for information in real time as to what may lie in a sight compromised pedestrian's path. Additionally, buildings, street signs, street curbs and the like have their own particular designs, sizes, placements, heights and so forth that sighted individuals can immediately take into account and navigate through with ease but that are terribly intimidating to individuals that have diminished vision. For sighted individuals it would also be of value in certain situations, particularly when traveling on business or pleasure, to have a directional system that can provide them with detailed real time information about their immediate surroundings and directions to particular locations.

Accordingly, there is a strong need for a system that can provide to sighted or visually impaired individuals reliable and accurate real time information about their immediate surroundings as well as direction assistance to a particular destination.

### SUMMARY OF THE INVENTION

The present invention is a device for providing real time information about a person's immediate surroundings so they can be safely and accurately guided to their particular destination. The invention herein includes a video camera or cameras that the user carries on their person and that generates streaming video of their environment. The camera or cameras are connected by wire or wirelessly to a transmitting device such as a cell phone. The cell phone is GPS enabled and is used to send the video signal and the GPS location information to a location where guide persons monitor the user's progress by viewing their video feed and GPS coordinates. The guides also have a telephonic connection to the user so they can speak with them.

In one embodiment, a pair of video cameras are mounted to headgear wherein one camera is facing forward and one to the rear in order to provide close to a 360 degree view of the user's surroundings. When the user wants to go to a particular destination they would call up the guide service and state where they want to go. Since the strength of a direct GPS signal sent by the asynchronous orbiting satellites is rather low, the user may be in a location where they guidance service can not receive a current GPS signal and know their precise location. Thus, the guide service will check with the user as to their current location and compare that with the GPS data they have. If there is a mis-match the guide service can nevertheless provide a map route based on the start point provided by the user or based on their last known GPS location.

Those of skill will understand that certain locations or cities will have a differential GPS system that is coordinated to work with the satellite based system that provides a stronger signal in a local area in order to diminish the signal attenuating effect of being in a building or walking between tall building structures in a downtown area. It will also be understood that the video and voice data will typically be transmitted wirelessly over the user's particular cell phone system which will also be more robust, particularly in urban areas, than is seen with the GPS satellite signals. Thus, once the guide service verifies that it is receiving a video feed the user can begin walking to their destination as the guide service provides real time information to them.

It can be understood that since the video information is seen by the guide service in real time the guide person assigned to the user can provide them with current information as to any obstacles that may lie in their path and give them the appropriate instructions on what actions should be taken. Where two or more cameras are being used the guide person can be presented with a split screen showing the simultaneous views from each camera. At an intersection the user can be requested to look to their right and left as is required to permit proper guidance as to street crossings.

The present invention also has value for sighted individuals and particularly when they are traveling to area with which they are unfamiliar. Whereas, a constant video feed may not be required in the case of a sighted person, a quick view of the individual's surroundings combined with the GPS information can provide the guide service personnel with information can permit them to quickly resolve a problem, such as in the case where the user is confused as to their location or having trouble finding a particular address. For sighted individuals a body mounted video camera may not be needed and can be substituted by their cell phone. Most cell phones include a photo/video recording capability and could be used to create a handheld video feed to the guide service. Once the user's precise location is determined they can be provided with directions to quickly resolve their problem.

The present invention could also be of value to people on vacation by providing directions to places of interest based on their present location, interests, ages and the like. It is also contemplated that the present invention could be of value as a security device for persons on foot, e.g. a college student walking on campus in the evening, or even for on-duty police officers. A rear view camera in particular could be used to provide the guide person with information about suspicious activity by individuals behind the user that could then be conveyed to them. The guide person could also at any time immediately contact emergency personnel, for example, campus security in the case of a student, should a threatening situation arise. The video feed could be recorded and provide admissible court evidence should some type of assaults or harassment be perpetrated. Thus, over time, knowledge of such recording capacity itself would be a strong deterrent to crime.

### BRIEF DESCRIPTION OF THE FIGURES

A better understanding of the structure, function, operation and the objects and advantages of the present invention can be had by reference to the following detailed description which refers to the following figures, wherein:

FIG. 1 shows a diagrammatic view of an embodiment of the present invention.

FIG. 2 shows a perspective view of headgear usable in the present invention.

### DETAILED DESCRIPTION

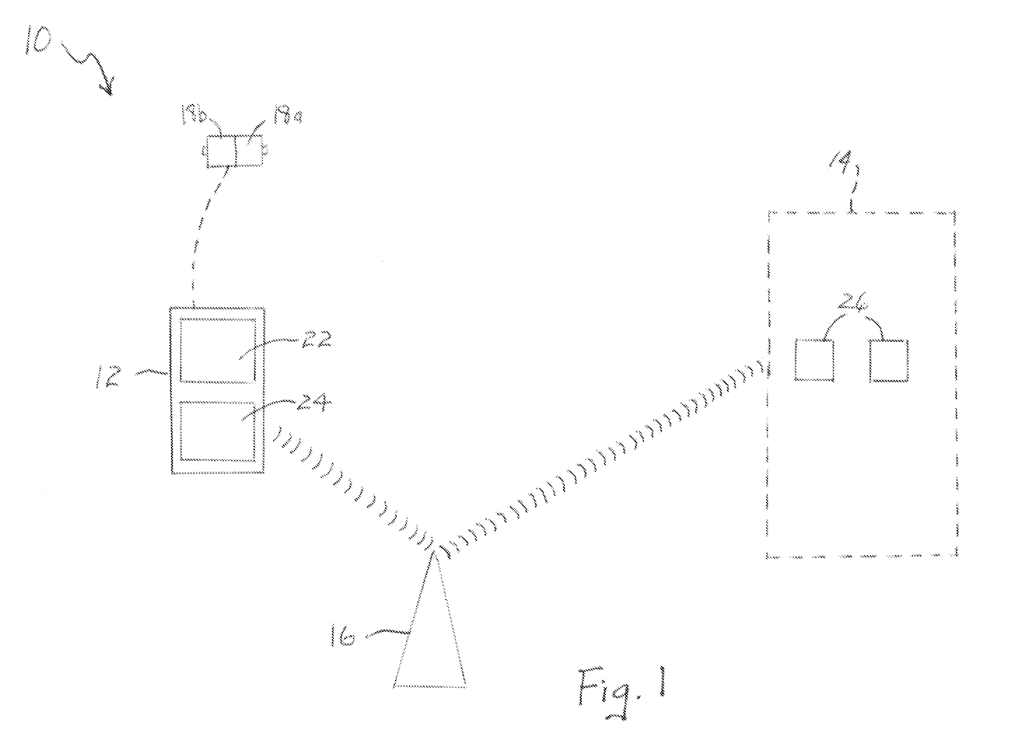

As seen in FIG. 1, a diagrammatic view of an embodiment of the guidance system of present invention is shown and referred to by the numeral 10. System 10 includes a portable communication device such as a cell phone 12 that provides for verbal communication to a remote guidance facility 14 via a communication infrastructure 16. Clearly, the user would have the choice of communicating verbally using a wireless head set, wired head phones or using a speakerphone option, all of which being available on most cell communication devices. Device 12 includes a video display 22 and is GPS enabled so that the location of the user when in possession thereof can be determined. Device 12 can also optionally include a three dimensional/tactile display 24 in addition to or as a replacement of screen 22.

One or more video cameras 18 can be physically secured to a user, not shown, who is also in possession of the communication device 12. Cameras 18 are connected either by wire or wirelessly to communication device 12. Device 12 has the capacity to send streaming video images as produces by cameras 18 to facility 14 and can also optionally include voice recognition software for enabling voice command and control ability thereof by a user.

Facility 14 includes guidance personnel, not shown, assigned to monitor video displays 26 that receive and show the streaming video as produced by cameras 18. The guidance personnel are also able to communicate telephonically with a user via device 12. The invention herein also includes the software capability that provides for the integration of a user's GPS data with a map database so that a user's location can be shown on a map and that information sent to them and shown on video display 22 and/or on a tactile display 24. The map database software also has the ability to determine and show on displays 22, 24 and 26 a desired route from an entered starting point to an entered destination point.

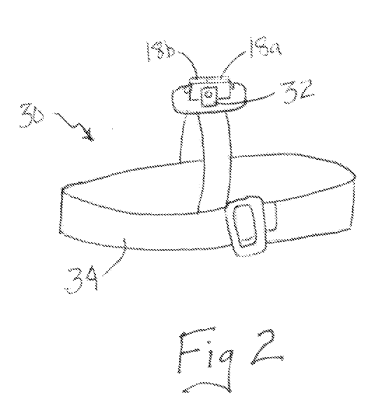

As seen by referring to FIG. 2 a video camera mounting device is comprised of a headgear unit 30 having, for example, a top adjustable mounting device 32 for retaining and adjusting the orientation of a forward facing camera 18a and a rearward facing camera 18b. Unit 30 includes one or more adjustable and/or elastic straps 34 to permit securing to the head of a user. In this manner a clear unobstructed view can be had by each of the cameras 18a and 18b and the user is not required to hold the cameras thereby freeing up their hands of that duty.

In operation, a user 20 may first contact facility 14 and be assigned to a particular guidance person who can now view the streaming video from one or more cameras 18. Where more than one camera 18 is used and working simultaneously, the guidance person's display can show a split screen showing the video from each of the plurality of cameras. The user 20 and the guidance person are also in verbal communication and the user's GPS location is being sent to the guidance person. It is well understood that regardless if the user is communicating through wireless or wired headset or a speakerphone a microphone is required to receive the user's speech so that it can be transmitted to the guide person. It is also understood that the microphone can pick up background noise that will also be transmitted to the guide person. This audio information can also be of great value to the guide person in assisting the user to safely navigate from one place to another.

The user will be requested to verify their position as best they are possible to see if the GPS data is accurate or reflects simply a last known or calculated position should the GPS signal not be working properly or of insufficient strength. It can be understood though that a current precise location as determined by a GPS system is not always necessary. The video feed can oftentimes be fully sufficient to provide the guide person with information to determine the user's location. The guidance person will also give the user instructions to stand and hold their head level to verify that they are receiving the video feed and if any adjustments need to be made, for example, to the adjustment device 32 regarding the orientation of the cameras. If no feed is being received then the guide and user can go through a protocol to determine if the cameras 18 are properly connected, turned on, have sufficient power and so forth.

Once all systems are working the guidance person can inquire as to the user's desired destination and can enter that request into the map database and generate a route for the user which route can be communicated to the user via the display 22 of their communication device 12. Where the user is sight impaired the assigned guidance person can send route information via the tactile display 26 and begin to give very specific directions to such individual based upon what the guidance person sees in the video feed. In this manner a visually impaired person can be given very precise directions along their entire route as they walk to their destination. Thus, the guidance person can essentially lead the user to their destination essentially as well as if they were walking next to them. For a person that is not sight impaired the guidance may not need to provide continuous assistance as it might be sufficient based on the initial video feed to ascertain their position and send them directions and route information adequate to get them to their destination. Of course, if the sighted user encounters further difficulties or confusion they can always re-contact the guidance person for additional instructions.

Those of skill will appreciate that a sighted or sight impaired user may not require the camera headgear as seen in FIG. 2. It may be sufficient to simply hold a video camera or to use a communication device 12 comprising a cell phone having a suitable video camera as a component thereof. Thus, the user can then simply hold and pan their device 12 sufficient to give the guide person the information needed to ascertain location and guide instructions. Of course, the head gear shown herein is not intended to be limiting in any fashion it being understood that a camera or cameras if mounting on the user's person was desirable, could be mounted to a user's shoulder, chest, back or any suitable location on their body. In the case of a physically impaired individual the one or more cameras could be mounted to a wheel chair or a walker. It is also possible, particularly in the case where one camera is used, to have it secured to a mounting device that permits a 360 degree rotation thereof. Such a mounting can be made to be adjustable manually or could be powered. In the latter case, the control thereof is provided by the user and could also be by that of the guide person.

It is additionally contemplated that the present invention will have utility for individuals that may be walking in an area and/or at particular time of the day where personal security is an issue. Thus, a guidance person having a front and rear view of a user as they walk can alert the user to any issues of concern such as a person or persons following them and suggest they possibly enter a public building or change course. The guidance person can also have the capacity to record the user's video feed should anyone approach the user in an unwelcomed manner and be able to separately alert authorities should the user need protection. It would also be possible for the guidance person to summon medical care should the user fall ill or have an accident and provide directions to the user's precise location. Such a device could have great utility for those in law enforcement or the military when encountering very hostile individuals or territory.

Those of skill will understand that here are many modifications and changes to the present invention that can be made thereto that will nevertheless remain within the sprit and scope of the claims thereof as set out below.

What is claimed is:

1. A system for providing information to a user about their surroundings, comprising: a communication device for permitting verbal communication between a user and a guide person located at a remote facility, and one or more video cameras for providing a feed of video information to the guide person concerning the user's immediate surroundings so the guide can assist the user.

2. The system as defined in claim 1 and the communication device having GPS capability for determining the user's location and providing such information to the guide person.

3. The system as defined in claim 1 and the guide person providing guidance instructions to the user based on the feed of video information to the guide person so the user can navigate from an initial location to a desired destination location.

4. The system as defined in claim 1 and the communication device having the capacity for receiving route information from the guide person and displaying it to the user.

5. The system as defined in claim 1 and the one or more video cameras mountable to the person of the user.

6. The system as defined in claim 1 and the one or more video cameras being hand held by the user.

7. The system as defined in claim 6 and the one or more video cameras comprising a cell phone having the capability of creating a live video stream.
